(19) United States
(12) Patent Application Publication
(10) Pub. No.: US 2005/0113147 A1
(43) Pub. Date: May 26, 2005

(54) Methods, electronic devices, and computer program products for generating an alert signal based on a sound metric for a noise signal

(76) Inventors: Daniel J. VanEpps JR., Apex, NC (US); William Chris Eaton, Cary, NC (US)

Correspondence Address: D. Scott Moore;Myers Bigel Sibley & Sajovec, Post Office Box 37428, Raleigh, NC, 27627, US

(21) Appl. No.: 10/723,776

(22) Filed: Nov. 26, 2003

(51) Int. Cl. H04M 1/00; H04B 1/38

(52) U.S. Cl. 455/567; 455/550.1

(57) ABSTRACT

An electronic device is operated by receiving a noise signal and generating a sound metric for the noise signal. An alert signal is generated based on the sound metric. An electronic device may also be operated by providing a plurality of alert profiles. A user may select one of the plurality of alert profiles and an alert signal may be generated that is based on the selected one of the plurality of alert profiles. An electronic device may be further operated by providing a plurality of alert profiles. A noise signal may be received and one of the plurality of profiles may be selected responsive to receiving the noise signal. An alert signal may be generated based on the selected one of the plurality of alert profiles.

### BACKGROUND OF THE INVENTION

The present invention relates to signal processing technology, and, more particularly, to methods, electronic devices, and computer program products for generating an alert signal for an electronic device.

Electronic devices, such as mobile terminals, typically have an alert signal to notify the user when an incoming communication, such as a call, arrives. Because electronic devices may be used in a variety of environments, some of which may be relatively noisy and some of which may be relatively quiet, an audible alert signal may not always have an appropriate loudness level or volume. One approach is to use a vibration mechanism as an alert signal instead of an audible notification. Unfortunately, a vibration mechanism typically only works if the electronic device is on or in relatively close proximity to the user's body.

### SUMMARY

According to some embodiments of the present invention, an electronic device is operated by receiving a noise signal and generating a sound metric for the noise signal. An alert signal is generated that is based on the sound metric.

In other embodiments of the present invention, the alert signal may be generated so as to have a spectral composition that is based on the sound metric.

In other embodiments of the present invention, the sound metric is a loudness profile and the sound metric may be generated by performing a Fourier transform on the noise signal to obtain a frequency domain representation of the noise signal. A distribution of sones/bark versus bark for the frequency domain representation of the noise signal may be calculated using an ISO 532B loudness calculation method. An overall loudness may be determined for the noise signal and a loudness in at least one critical band for the noise signal may be determined based on the distribution of sones/bark versus bark. The loudness profile may be the overall loudness of the noise signal and the loudness in at least one critical band.

In still other embodiments of the present invention, the alert signal may be generated by determining a power value for the alert signal based on the loudness profile for the noise signal. A transfer function may determined for an alert signal transmit filter based on the loudness profile for the noise signal. The alert signal may be transmitted at the power value using the alert signal transmit filter.

In further embodiments of the present invention, the sound metric is a loudness profile and a sharpness profile.

In still further embodiments of the present invention, the noise signal is received responsive to receiving an incoming communication at the electronic device.

In still further embodiments of the present invention, an incoming communication is received at the electronic device after receiving the noise signal and generating the sound metric for the noise signal. The alert signal is generated responsive to receiving the incoming communication.

In still further embodiments of the present invention, the electronic device is a mobile terminal.

In other embodiments of the present invention, a plurality of alert profiles may be provided and a user may select one of the plurality of alert profiles. An alert signal may be generated that is based on the selected one of the plurality of alert profiles.

In still other embodiments of the present invention, a plurality of alert profiles may be provided and a noise signal may be received. One of the plurality of profiles may be selected responsive to receiving the noise signal. An alert signal may be generated based on the selected one of the plurality of alert profiles.

Although described above primarily with respect to method aspects of the present invention, it will be understood that the present invention may be embodied as methods, electronic devices, and/or computer program products.

### BRIEF DESCRIPTION OF THE DRAWINGS

Other features of the present invention will be more readily understood from the following detailed description of specific embodiments thereof when read in conjunction with the accompanying drawings, in which:

FIG. 1 is a block diagram that illustrates a mobile terminal in accordance with some embodiments of the present invention;

FIG. 2 is a block diagram that illustrates a signal processor that may be used in electronic devices, such as the mobile terminal of FIG. 1, in accordance with some embodiments of the present invention; and

FIGS. 3 and 4 are flowcharts that illustrate operations for generating an alert signal in accordance with some embodiments of the present invention;

FIG. 5 is a graph that illustrates a loudness of an ambient noise signal in accordance with some embodiments of the present invention; and

FIG. 6 is a flowchart that illustrates operations for generating an alert signal in accordance with some embodiments of the present invention.

### DETAILED DESCRIPTION

While the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention as defined by the claims. Like reference numbers signify like elements throughout the description of the figures. It should be further understood that the terms “comprises” and/or “comprising” when used in this specification are taken to specify the presence of stated features, integers, steps, operations, elements, and/or components, but do not preclude the presence or addition of one or more other features, integers, steps, operations, elements, components, and/or groups thereof.

The present invention may be embodied as methods, electronic devices, and/or computer program products. Accordingly, the present invention may be embodied in hardware and/or in software (including firmware, resident software, micro-code, etc.). Furthermore, the present invention may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection having one or more wires, a portable computer diskette, a random access memory (RAM), a read-only memory (ROM), an erasable programmable read-only memory (EPROM or Flash memory), an optical fiber, and/or a compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

The present invention is described herein in the context of generating an alert signal in a mobile terminal. It will be understood, however, that the present invention may be embodied in other types of electronic devices that use an alert signal or mechanism to notify a user of an event, such as an incoming call, communication, or a scheduled event. Moreover, as used herein, the term “mobile terminal” may include a satellite or cellular radiotelephone with or without a multi-line display; a Personal Communications System (PCS) terminal that may combine a cellular radiotelephone with data processing, facsimile and data communications capabilities; a PDA that can include a radiotelephone, pager, Internet/intranet access, Web browser, organizer, calendar and/or a global positioning system (GPS) receiver; and a conventional laptop and/or palmtop receiver or other appliance that includes a radiotelephone transceiver. Mobile terminals may also be referred to as “pervasive computing” devices.

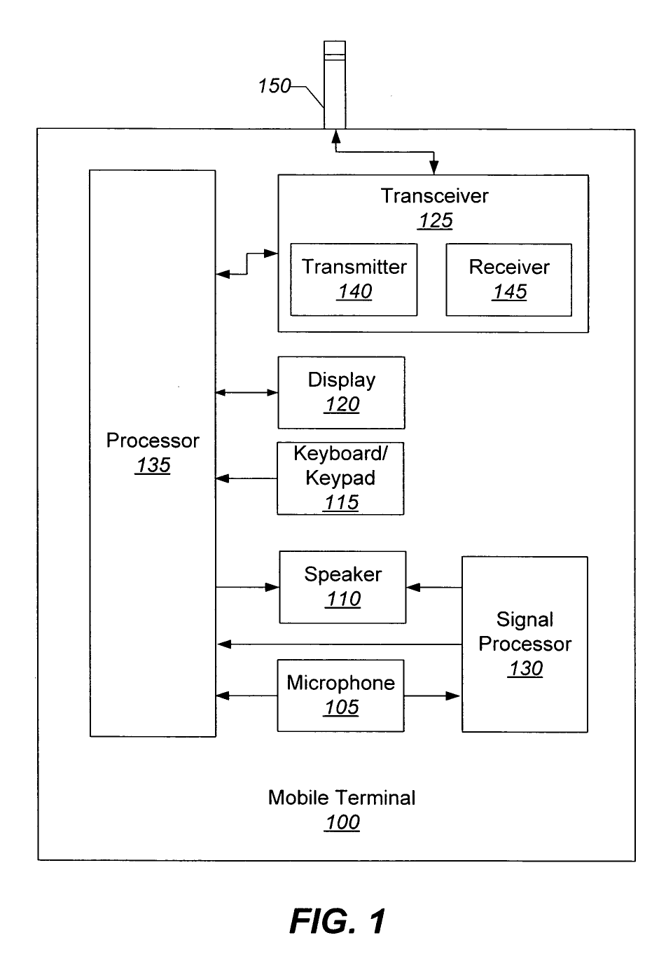

Referring now to FIG. 1, an exemplary mobile terminal 100, in accordance with some embodiments of the present invention, includes a microphone 105, a speaker 10, a keyboard/keypad 115, a display 120, a transceiver 125, and a signal processor 130 that communicate with a processor 135. The microphone 105 may represent a single microphone or may represent multiple microphones. The transceiver 125 includes a transmitter circuit 140 and a receiver circuit 145, which, respectively, transmit outgoing radio frequency signals to, for example, base station transceivers and receive incoming radio frequency signals from, for example, the base station transceivers via an antenna 150. The radio frequency signals transmitted between the mobile terminal 100 and the base station transceivers may comprise both traffic and control signals (e.g., paging signals/messages for incoming calls), which are used to establish and maintain communication with another party or destination. The radio frequency signals may also comprise packet data information, such as, for example, cellular digital packet data (CDPD) information. The foregoing components of the mobile terminal 100, without the capabilities of the present invention, may be included in many conventional mobile terminals and their functionality, with respect to such conventional operations, is generally known to those skilled in the art.

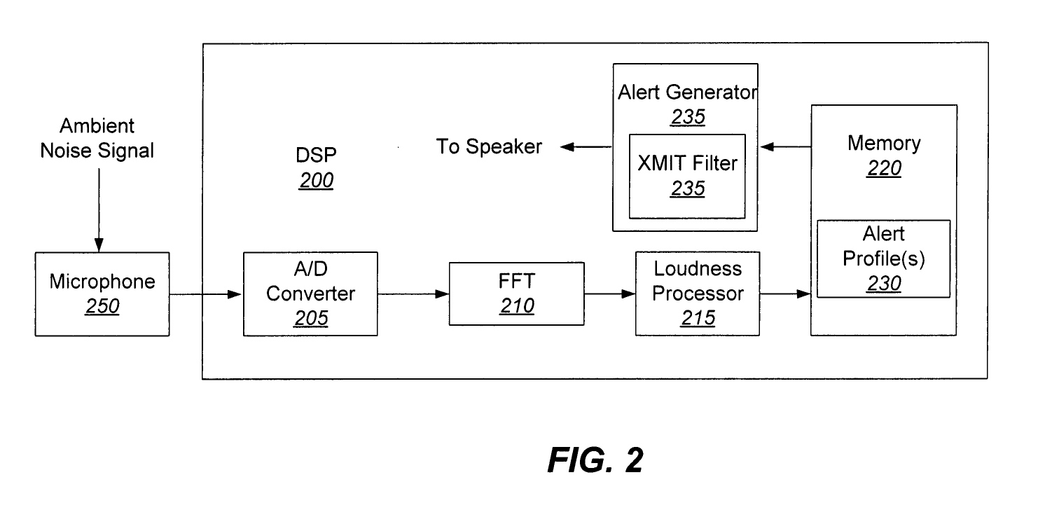

As shown in FIG. 1, the mobile terminal 100 includes a signal processor 130 that is responsive to ambient noise signal received through the microphone 105 and is configured to generate an alert signal that has a spectral composition that is based on a sound metric determined for the ambient noise signal. As used herein, spectral composition means frequency spectrum and/or power level. Any background noise picked up by the microphone 105 may be considered noise and/or a particular signal, which may be generated by a particular source, may be identified as noise. In accordance with some embodiments of the present invention, the signal processor 130 may be configured to determine a loudness profile for the ambient noise signal that includes an overall loudness measure for the noise signal along with a loudness measure of the noise signal in one or more critical bands. For example, sounds that compete for the same nerve endings on the basilar membrane of the inner ear may be considered to be in the same critical band. Generally, a critical band may be about 90 Hz wide for sounds having frequencies below 200 Hz and about 900 Hz wide for sounds having frequencies around 5000 Hz. Based on this loudness profile, the signal processor 130 may be configured to determine a power value for the alert signal and to determine a transfer function for an alert signal transmit filter. Determining the transfer function may comprise selecting coefficients for the alert signal transfer filter. The alert signal may then be transmitted using the alert signal transmit filter. A signal processor that may be used to implement the signal processor 130, in accordance with some embodiments of the present invention, will now be described with respect to FIG. 2.

As shown in FIG. 2, a digital signal processor (DSP) 200, in accordance with some embodiments of the present invention, includes an analog-to-digital (A/D) converter 205, a fast-Fourier transform (FFT) module 210, a sound metric processor 215, a memory 220, and an alert generator 225. The A/D converter 205 may be configured to convert an analog ambient noise signal received from, for example, one or more microphones 250, to a sequence of digital samples. The FFT module 210 may be configured to perform a Fourier transform on the digital samples of the ambient noise signal so as to obtain a frequency domain representation of the ambient noise signal. The sound metric processor 215 may be configured to generate a loudness profile for the ambient noise signal that includes an overall loudness measure for the noise signal along with a loudness measure of the noise signal in one or more critical bands based on the frequency domain representation of the ambient noise signal.

In some embodiments of the present invention, the loudness processor may be configured to generate a sharpness profile for the ambient noise signal based on the frequency domain representation of the ambient noise signal. Sharpness is defined as the ratio of high frequency loudness to overall loudness. Generation of the loudness profile and the sharpness profile by the sound metric processor 215 will be described in greater detail below.

The loudness profile and/or the sharpness profile may be stored in the memory 220 as alert profile(s) 230. The alert generator 225 may be configured to access the alert profile(s) 230 in the memory 220 and to use the alert profile(s) to determine a power value for the alert signal and a transfer function for an alert signal transmit filter 235. The alert generator 225 may transmit the alert signal through, for example, the speaker 110 of FIG. 1, by using the alert signal transmit filter 235 so that the alert signal's loudness exceeds the ambient noise loudness in selected frequency bands, such as those that are more relevant to human hearing. In some embodiments, the alert signal's loudness may be made to exceed the ambient noise signal's loudness across the entirety of the audible spectrum. According to some embodiments of the present invention, an alert signal can be generated in a certain frequency spectrum or range in which the loudness of the ambient noise signal is relatively low. Thus, according to some embodiments of the present invention, the frequency spectrum of the alert signal may be determined based on the loudness profile and/or sharpness profile of the noise signal, the power level of the alert signal may be determined based on the loudness profile and/or sharpness profile of the noise signal, or both the frequency spectrum and the power level of the alert signal may be determined based on the loudness profile and/or the sharpness profile of the noise signal.

Although FIG. 2 illustrates an exemplary software and/or hardware architecture of a signal processor that may be used to generate an alert signal in an electronic device, such as a mobile terminal, it will be understood that the present invention is not limited to such a configuration but is intended to encompass any configuration capable of carrying out the operations described herein. Moreover, computer program code for carrying out operations of the modules comprising the DSP 200 discussed above may be written in a high-level programming language, such as C or C++, for development convenience. Computer program code for carrying out operations of the present invention may also be written in other programming languages, such as, but not limited to, interpreted languages. Some modules or routines may be written in assembly language or even micro-code to enhance performance and/or memory usage. It will be further appreciated that the functionality of any or all of the program and/or processing modules of the DSP 200 may also be implemented using discrete hardware components, one or more application specific integrated circuits (ASICs), or a microcontroller.

The present invention is described hereinafter with reference to flowchart and/or block diagram illustrations of methods, electronic devices, and computer program products in accordance with some embodiments of the invention. These flowchart and/or block diagrams further illustrate exemplary operations of the mobile terminal and signal processor architectures of FIGS. 1 and 2. It will be understood that each block of the flowchart and/or block diagram illustrations, and combinations of blocks in the flowchart and/or block diagram illustrations, may be implemented by computer program instructions and/or hardware operations. These computer program instructions may be provided to a processor of a general purpose computer, a special purpose computer, or other programmable data processing apparatus to produce a machine, such that the instructions, which execute via the processor of the computer or other programmable data processing apparatus, create means for implementing the functions or acts specified in the flowchart and/or block diagram block or blocks.

These computer program instructions may also be stored in a computer usable or computer-readable memory that may direct a computer or other programmable data processing apparatus to function in a particular manner, such that the instructions stored in the computer usable or computer-readable memory produce an article of manufacture including instructions that implement the function or act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions or acts specified in the flowchart and/or block diagram block or blocks.

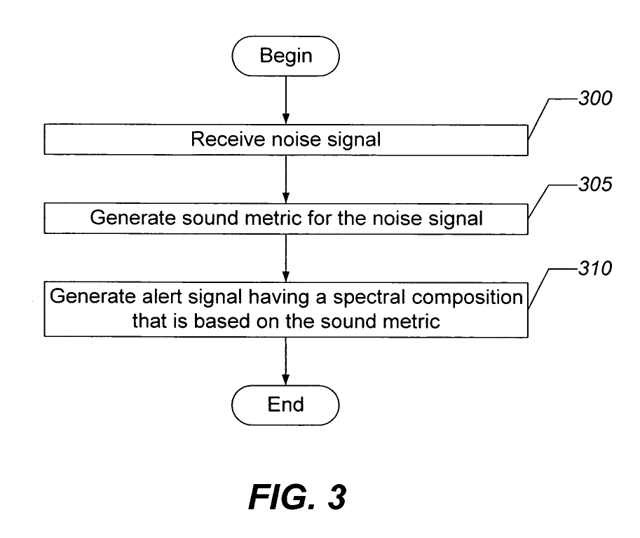

Referring now to FIG. 3, operations begin at block 300 where the microphone 100 of FIG. 1, for example, receives an ambient noise signal. At block 305, the sound metric processor 215 of FIG. 2, for example, may generate a sound metric for the noise signal. The alert generator 225 of FIG. 2, for example, may then generate an alert signal that has a spectral composition that is based on the sound metric at block 310. In accordance with some embodiments of the present invention, the ambient noise signal may be received and a sound metric may be generated for the ambient noise signal, which may then be saved as an alert profile 230 in the memory 220 as discussed above with respect to FIG. 2. When an incoming communication is received by the mobile terminal or electronic device, the alert signal may be generated based on a previously stored alert profile 230.

In accordance with some embodiments of the present invention, various alert profiles 230 may be stored in the memory 220, which corresponds to various types of environments, such as, for example, an office environment, an arena environment, an automobile environment, a home environment, etc. When an incoming communication is received by the mobile terminal or electronic device, the sound metric processor 215 may analyze the loudness of the ambient noise signal and identify one of the previously stored alert profiles 230 for the alert generator 225 to use in generating the alert signal.

In accordance with some embodiments of the present invention, various alert profiles 230 may be stored in the memory 220, which correspond to various types of environments as discussed above. A user may then select a particular alert profile for the alert generator 225 to use in generating the alert signal. In these embodiments, the sound metric processor need not perform an analysis of the ambient noise level when an incoming communication or event is received. In addition to such factors as external environment, the alert profiles 230 may also be tailored to the preferences of a particular user and may take into account, for example, the user's hearing ability, how the user holds the electronic device, and/or where the electronic device is kept relative to the user.

In other embodiments of the present invention, the ambient noise signal may be received, a sound metric generated therefore, and an alert signal generated that is based on the sound metric in response to receiving an incoming communication at the mobile terminal or electronic device. That is, an alert signal loudness may be adjusted dynamically in response to an incoming communication in accordance with some embodiments of the present invention.

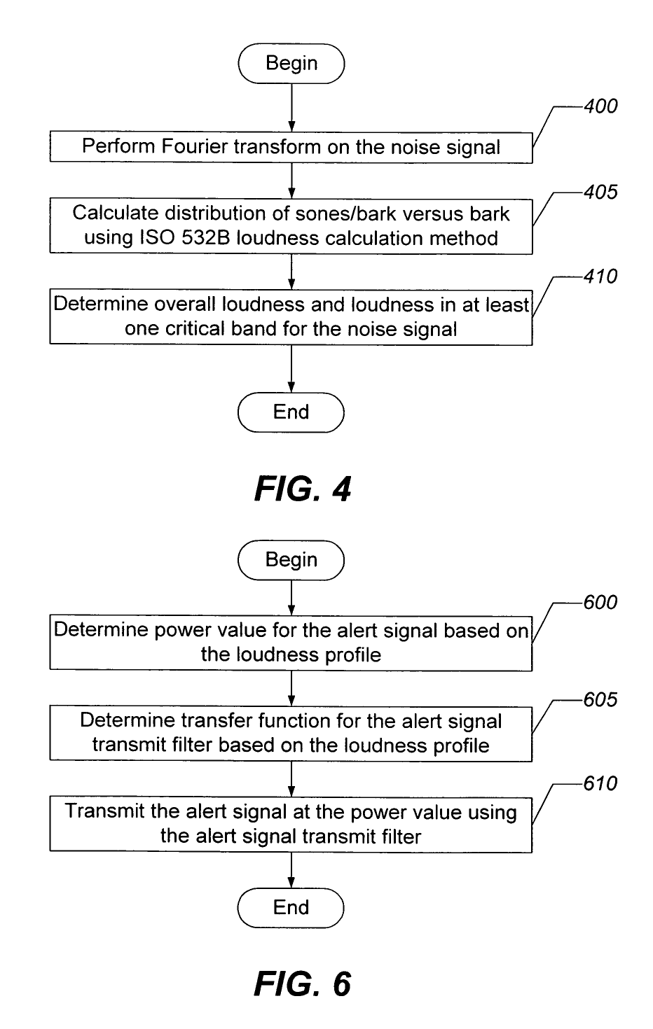

Referring now to FIG. 4, operations for generating a sound metric, in accordance with some embodiments of the present invention, will now be described. Operations begin at block 400 where the FFT module 210 of FIG. 2, for example, performs a Fourier transform on the ambient noise signal. The sound metric processor 215, for example, may then calculate the distribution of sones/bark versus bark using the ISO 532B loudness calculation method at block 405. Calculation of the ISO 532B loudness is described in the Deutsches Institut fir Normung E.V. (DIN) 45631 Standard entitled “Procedure For Calculating Loudness Level And Loudness,” the disclosure of which is hereby incorporated herein by reference. FIG. 5 illustrates an exemplary distribution of sones/bark versus bark for am ambient noise signal. At block 410, the sound metric processor 215 may determine an overall loudness and the loudness in one or more critical bands for the ambient noise signal. The overall loudness may be determined by calculating the area under the curve in FIG. 5. In other embodiments of the present invention, the sound metric processor 215 may determine a sharpness for the ambient noise signal as discussed above. The overall loudness along with the loudness in one or more critical bands for the ambient noise signal may define a loudness profile, which may be stored as an alert profile 230 in the memory 220 of FIG. 2.

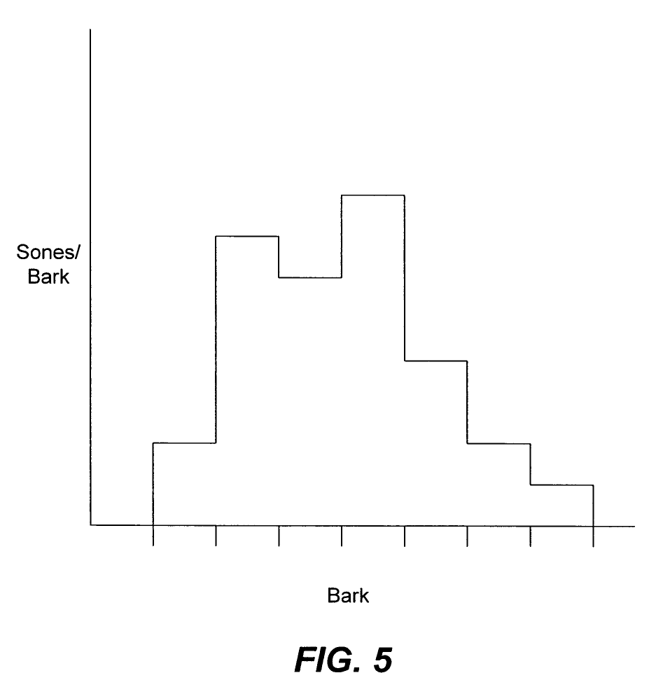

Referring now to FIG. 6, operations for generating an alert signal, in accordance with some embodiments of the present invention, will now be described. Operations begin at block 600 where the alert generator 225 of FIG. 2, for example, determines a power value for the alert signal based on the loudness profile for the ambient noise signal. The alert generator 225 may determine the transfer function for the alert signal transmit filter 235 at block 605 based on the loudness profile. At block 610, the alert generator 225 may transmit the alert signal at the power value using. the alert signal transmit filter 235, which, advantageously, may allow the alert signal's loudness to exceed the ambient noise loudness in selected frequency bands that are, for example, more relevant to human hearing. As discussed above, however, the alert signal may be generated to have a loudness that exceeds the loudness of the noise signal across the entirety of the audible spectrum in some embodiments of the present invention. Moreover, the present invention may allow the power level and/or the frequency spectrum to be set so to improve the likelihood that the user can hear the alert signal over the ambient noise in the environment. In some embodiments, this may involve setting the frequency of the alert signal to a frequency band where the ambient noise loudness is relatively low based on the sound metric of the noise signal. In other embodiments, this may involve shifting the frequency of the alert signal to a frequency band where the ambient noise loudness is relatively low while also adjusting a power level of the alert signal based on the sound metric of the noise signal. In still other embodiments of the present invention, the power level of the alert signal may be adjusted based on the sound metric of the noise signal.

According to some embodiments of the present invention, an alert signal can be generated in a certain frequency spectrum or range in which the loudness of the ambient noise signal is relatively low. Thus, according to some embodiments of the present invention, the frequency spectrum of the alert signal may be determined based on the loudness profile and/or sharpness profile of the noise signal, the power level of the alert signal may be determined based on the loudness profile and/or sharpness profile of the noise signal, or both the frequency spectrum and the power level of the alert signal may be determined based on the loudness profile and/or the sharpness profile of the noise signal.

In accordance with some embodiments of the present invention, the loudness profiles and/or sharpness profiles generated by the sound metric processor 215 may be used by the processor 135 and/or transceiver 125 of FIG. 1 to facilitate, for example, generation of filter coefficients for such functions as received signal equalization and/or echo suppression.

The flowcharts of FIGS. 3, 4, and 6 illustrate the architecture, functionality, and operations of the mobile terminal 100 and DSP 200 hardware and/or software according to some embodiments of the present invention. In this regard, each block represents a module, segment, or portion of code, which comprises one or more executable instructions for implementing the specified logical function(s) or act(s). It should also be noted that in other implementations, the function(s) or act(s) noted in the blocks may occur out of the order noted in FIG. 3, 4, and 6. For example, two blocks shown in succession may, in fact, be executed substantially concurrently or the blocks may sometimes be executed in the reverse order, depending on the operations involved.

Many variations and modifications can be made to the embodiments described above without substantially departing from the principles of the present invention. All such variations and modifications are intended to be included herein within the scope of the present invention, as set forth in the following claims.

1. A method of operating an electronic device, comprising:
receiving a noise signal;
generating a sound metric for the noise signal; and
generating an alert signal based on the sound metric.

2. The method of claim 1, wherein generating the alert signal comprises:
generating the alert signal having a spectral composition that is based on the sound metric.

3. The method of claim 2, wherein the sound metric is a loudness profile and wherein generating the sound metric comprises:
performing a Fourier transform on the noise signal to obtain a frequency domain representation of the noise signal.

4. The method of claim 3, wherein generating the sound metric further comprises:
calculating a distribution of sones/bark versus bark for the frequency domain representation of the noise signal using an ISO 532B loudness calculation method; and
determining an overall loudness for the noise signal and a loudness in at least one critical band for the noise signal based on the distribution of sones/bark versus bark, the loudness profile comprising the overall loudness of the noise signal and the loudness in at least one critical band.

5. The method of claim 4, wherein generating the alert signal comprises:
determining a power value for the alert signal based on the loudness profile for the noise signal;
determining a transfer function for an alert signal transmit filter based on the loudness profile for the noise signal; and
transmitting the alert signal at the power value using the alert signal transmit filter.

6. The method of claim 5, wherein determining the transfer function for the alert signal transmit filter comprises:
selecting coefficients for the alert signal transmit filter.

7. The method of claim 1, wherein the sound metric comprises a loudness profile and/or a sharpness profile.

8. The method of claim 1, further comprising:
receiving an incoming communication and/or scheduled event at the electronic device; and
wherein receiving the noise signal comprises receiving the noise signal responsive to receiving the incoming communication.

9. The method of claim 1, further comprising:
receiving an incoming communication at the electronic device after receiving the noise signal and generating the sound metric for the noise signal; and
wherein generating the alert signal comprises generating the alert signal having the spectral composition that is based on the sound metric responsive to receiving the incoming communication.

10. The method of claim 1, wherein the electronic device is a mobile terminal.

11. A method of operating an electronic device, comprising:
providing a plurality of alert profiles;
receiving a user selection of one of the plurality of alert profiles; and
generating an alert signal that is based on the selected one of the plurality of alert profiles.

12. The method of claim 11, wherein generating the alert signal comprises generating the alert signal having a spectral composition that is based on the selected one of the plurality of alert profiles.

13. The method of claim 11, wherein generating the alert signal comprises:
determining a power value for the alert signal based on the selected one of the plurality of alert profiles for the noise signal;
determining a transfer function for an alert signal transmit filter the selected one of the plurality of alert profiles for the noise signal; and
transmitting the alert signal at the power value using the alert signal transmit filter.

14. A method of operating an electronic device, comprising:
providing a plurality of alert profiles; then
receiving a noise signal;
selecting one of the plurality of alert profiles responsive to receiving the noise signal; and
generating an alert signal that is based on the selected one of the plurality of alert profiles.

15. The method of claim 14, wherein generating the alert signal comprises generating the alert signal having a spectral composition that is based on the selected one of the plurality of alert profiles.

16. The method of claim 14, wherein generating the alert signal comprises:
determining a power value for the alert signal based on the selected one of the plurality of alert profiles for the noise signal;
determining a transfer function for an alert signal transmit filter the selected one of the plurality of alert profiles for the noise signal; and
transmitting the alert signal at the power value using the alert signal transmit filter.

17. An electronic device, comprising:
a receiver that is configured to receive a noise signal;
a sound metric processor that is configured to generate a sound metric for the noise signal; and
an alert generator that is configured to generate an alert signal that is based on the sound metric.

18. The electronic device of claim 17, where the alert generator is further configured to generate an alert signal having a spectral composition that is based on the sound metric.

19. The electronic device of claim 18, wherein the sound metric is a loudness profile and wherein the electronic device further comprises:
a Fourier transform module that is configured to obtain a frequency domain representation of the noise signal.

20. The electronic device of claim 19, wherein the sound metric processor is further configured to calculate a distribution of sones/bark versus bark for the frequency domain representation of the noise signal using an ISO 532B loudness calculation method and to determine an overall loudness for the noise signal and a loudness in at least one critical band for the noise signal based on the distribution of sones/bark versus bark, the loudness profile comprising the overall loudness of the noise signal and the loudness in at least one critical band.

21. The electronic device of claim 20 wherein the alert generator further comprises an alert signal transmit filter and wherein the alert generator is further configured to determine a power value for the alert signal based on the loudness profile for the noise signal, determine a transfer function for the alert signal transmit filter based on the loudness profile for the noise signal, and transmit the alert signal at the power value using the alert signal transmit filter.

22. The electronic device of claim 21, wherein the alert generator is further configured to select coefficients for the alert signal transmit filter.

23. The electronic device of claim 17, wherein the sound metric comprises a loudness profile and a sharpness profile.

24. The electronic device of claim 17, wherein the electronic device is a mobile terminal.

25. An electronic device, comprising:
means for receiving a noise signal;
means for generating a sound metric for the noise signal; and
means for generating an alert signal based on the sound metric.

26. The electronic device claim 25, wherein the means for generating the alert signal comprises:
means for generating the alert signal having a spectral composition that is based on the sound metric.

27. The electronic device of claim 26, wherein the sound metric is a loudness profile and wherein the means for generating the sound metric comprises:
means for performing a Fourier transform on the noise signal to obtain a frequency domain representation of the noise signal.

28. The electronic device of claim 27, wherein the means for generating the sound metric further comprises:
means for calculating a distribution of sones/bark versus bark for the frequency domain representation of the noise signal using an ISO 532B loudness calculation method; and
means for determining an overall loudness for the noise signal and a loudness in at least one critical band for the noise signal based on the distribution of sones/bark versus bark, the loudness profile comprising the overall loudness of the noise signal and the loudness in at least one critical band.

29. The electronic device of claim 28, wherein the means for generating the alert signal comprises:
means for determining a power value for the alert signal based on the loudness profile for the noise signal;
means for determining a transfer function for an alert signal transmit filter based on the loudness profile for the noise signal; and
means for transmitting the alert signal at the power value using the alert signal transmit filter.

30. An electronic device, comprising:
means for providing a plurality of alert profiles;
means for receiving a user selection of one of the plurality of alert profiles; and
means for generating an alert signal that is based on the selected one of the plurality of alert profiles.

31. An electronic device, comprising:
means for providing a plurality of alert profiles;
means for receiving a noise signal;
means for selecting one of the plurality of alert profiles responsive to receiving the noise signal; and
means for generating an alert signal that is based on the selected one of the plurality of alert profiles.

32. A computer program product for operating an electronic device, comprising:
a computer readable storage medium having computer readable program code embodied therein, the computer readable program code comprising:
computer readable program code configured to receive a noise signal;
computer readable program code configured to generate a sound metric for the noise signal; and
computer readable program code configured to generate an alert signal based on the sound metric.

33. The computer program product of claim 32, wherein the computer readable program code configured to generate the alert signal comprises:
computer readable program code configured to generate the alert signal having a spectral composition that is based on the sound metric.

34. The computer program product of claim 33, wherein the sound metric is a loudness profile and wherein the computer readable program code configured to generate the sound metric comprises:
computer readable program code configured to perform a Fourier transform on the noise signal to obtain a frequency domain representation of the noise signal.

35. The computer program product of claim 34, wherein the computer readable program code configured to generate the sound metric further comprises:
computer readable program code configured to calculate a distribution of sones/bark versus bark for the frequency domain representation of the noise signal using an ISO 532B loudness calculation method; and
computer readable program code configured to determine an overall loudness for the noise signal and a loudness in at least one critical band for the noise signal based on the distribution of sones/bark versus bark, the loudness profile comprising the overall loudness of the noise signal and the loudness in at least one critical band.

36. The computer program product of claim 35, wherein the computer readable program code configured to generate the alert signal comprises:
computer readable program code configured to determine a power value for the alert signal based on the loudness profile for the noise signal;
computer readable program code configured to determine a transfer function for an alert signal transmit filter based on the loudness profile for the noise signal; and
computer readable program code configured to transmit the alert signal at the power value using the alert signal transmit filter.

37. A computer program product for operating an electronic device, comprising:
a computer readable storage medium having computer readable program code embodied therein, the computer readable program code comprising:
computer readable program code configured to provide a plurality of alert profiles;
computer readable program code configured to receive a user selection of one of the plurality of alert profiles; and
computer readable program code configured to generate an alert signal that is based on the selected one of the plurality of alert profiles.

38. A computer program product for operating an electronic device, comprising:
a computer readable storage medium having computer readable program code embodied therein, the computer readable program code comprising:
computer readable program code configured to provide a plurality of alert profiles;
computer readable program code configured to receive a noise signal;
computer readable program code configured to select one of the plurality of alert profiles responsive to receiving the noise signal; and
computer readable program code configured to generate an alert signal that is based on the selected one of the plurality of alert profiles.
